(19) United States
(12) Patent Application Publication
(10) Pub. No.: US 2024/0387836 A1
(43) Pub. Date: Nov. 21, 2024

(54) SOLID OXIDE CELL STACK COMPRISING INTEGRATED INTERCONNECT, SPACER AND FIXTURE FOR A CONTACT ENABLING LAYER

(71) Applicant: TOPSOE A/S, Kgs. Lyngby (DK)

(72) Inventors: Thomas Heiredal-Clausen, Birkerød (DK); Jeppe Rass-Hansen, Copenhagen V (DK); Bengt Peter Gustav Blennow, Humlebæk (DK); Martin Refslund Nielsen, Birkerød (DK); Tobias Holt Nørby, Glostrup (DK); Rainer Küngas, Peetri (EE); Cliver Klitholm, Søborg (DK)

(73) Assignee: TOPSOE A/S, Kgs. Lyngby (DK)

(21) Appl. No.: 18/576,703

(22) PCT Filed: Mar. 15, 2022
(86) PCT No.: PCT/EP2022/056613

§ 371 Date: Jan. 4, 2024

(30) Foreign Application Priority Data
Jul. 7, 2021 (EP) 21184186.1

(51) Int. Cl. H01M 8/0247; H01M 8/026; H01M 8/0271; H01M 8/12; H01M 8/1213; H01M 8/2425

(52) U.S. Cl. CPC H01M 8/0247; H01M 8/026; H01M 8/0271; H01M 8/1213; H01M 8/2425; H01M 2008/1293

(57) ABSTRACT

A Solid Oxide Cell stack has an integrated interconnect and spacer. which is formed by bending a surplus part of the plate interconnect 180° to form a spacer part on top of the interconnect and connected to the interconnect at least by the bend and also providing a fixture for a contact enabling layer which is located on at least one side of the integrated interconnect and spacer.

### FIELD OF THE INVENTION

The invention relates to a Solid Oxide Cell (SOC) stack, in particular a Solid Oxide Electrolysis Cell (SOEC) stack or a Solid Oxide Fuel Cell (SOFC) stack, comprising an integrated interconnect and spacer, in particular an integrated interconnect and spacer comprising a fixture for a contact enabling layer in the SOC stack.

### BACKGROUND OF THE INVENTION

This invention can generally be used in a SOC stack-thus both in SOEC and SOFC mode even though for simplicity some parts of the description below relates to SOEC mode.

In SOC stacks which has an operating temperature between 600° C. and 1000°° C., preferably between 600°° C. and 850° C., several cell units are assembled to form the stack and are linked together by interconnects. Interconnects serve as a gas barrier to separate the anode and cathode sides of adjacent cell units, and at the same time they enable current conduction between the adjacent cells, i.e. between an anode of one cell and a cathode of a neighbouring cell. Further, interconnects are normally provided with a plurality of flow paths for the passage of process gas on both sides of the interconnect. To optimize the performance of a SOC stack, a range of positive values should be maximized without unacceptable consequence on another range of related negative values which should be minimized. Some of these values are:

| VALUES TO BE MAXIMIZED | VALUES TO BE MINIMIZED |
|---|---|
| Process gas utilization | Cost |
| electrical efficiency | Dimensions |
| lifetime | production time |
| | fail rate |
| | number of components |
| | Parasitic loss (heating, |
| | cooling, blowers . . . ) |
| | material use |

Almost all the above listed values are interrelated, which means that altering one value will impact other values. Some relations between the characteristics of process gas flow in the cells and the above values are mentioned here:

### Process Gas Utilization:

The flow paths on the interconnect should be designed to seek an equal amount of process gas to each cell in a stack, i.e. there should be no flow-“short-cuts” through the stack.

### Parasitic Loss:

Design of the process gas flow paths in the SOC stack and its cell units should seek to achieve a low pressure loss per flow volume, which will reduce the parasitic loss to blowers.

### Electric Efficiency:

The interconnect leads current between the anode and the cathode layer of neighbouring cells. Hence, to reduce internal resistance, the electrically conducting contact points (hereafter merely called “contact points”) of the interconnect should be designed to establish good electrical contact to the electrodes (anode and cathode) and the contact points should no where be far apart, which would force the current to run through a longer distance of the electrode with resulting higher internal resistance.

### Lifetime:

It is desirable that the lifetime of an SOC stack is maximized, i.e. that in SOFC mode it can be used to produce as much electricity as possible and that in SOEC mode the amount of electrolysis product (e.g. H₂ and/or CO) is maximized. Stack lifetime depends on a number of factors, including the choice of the interconnect and spacer, on flow distribution on both process gas sides of the interconnect, evenly distributed protective coating on the materials, on the operating conditions (temperature, current density, voltage, etc), on cell design and materials, edge re-oxidation which lowers the lifetime and many other factors.

### Cost:

The cost contribution of the interconnects (and spacers) can be reduced by not using noble materials, by reducing the production time of the interconnect and spacer, minimizing the number of components and by minimizing the material loss (the amount of material discarded during the production process).

### Dimensions:

The overall dimensions of a fuel stack are reduced, when the interconnect design ensures a high utilization of the active cell area. Dead-areas with low process gas flow should be reduced and inactive zones for sealing surfaces should be minimized.

### Production Time.

Production time of the interconnect and spacer itself should be minimized and the interconnect design should also contribute to a fast assembling of the entire stack. In general, for every component the interconnect design renders unnecessary, there is a gain in production time.

### Fail Rate.

The interconnect and spacer production methods and materials should permit a low interconnect fail rate (such as unwanted holes in the interconnect gas barrier, uneven material thickness or characteristics). Further the fail-rate of the assembled cell stack can be reduced when the interconnect design reduces the total number of components to be assembled and reduces the length and number of seal surfaces.

### Number of Components.

Apart from minimizing errors and assembling time as already mentioned, a reduction of the number of components leads to a reduced cost.

The way the anode and cathode gas flows are distributed in a SOC stack is by having a common manifold for each of the two process gasses. The manifolds can either be internal or external. The manifolds supply process gasses to the individual layers in the SOC stack by the means of channels to each layer. The channels are normally situated in one layer of the repeating elements which are comprised in the SOC stack, i.e. in the spacers or in the interconnect.

Interconnects and spacers which are made of sheet metal, are normally made of two separate parts of sheet material, which are sealed together in the SOC stack. This requires sealing between interconnect and spacer, plus handling of the separate components in the production. Furthermore, as the two separate sheet pieces often have the same outer dimensions, a lot of material, is wasted when most of the centre material of the spacer sheet is removed (e.g. stamped out).

Solid oxide electrolysis cells (SOEC) can be used to convert H2O to H2, CO2 to CO, or a combination of H2O and CO2 to syngas (H2 and CO). This conversion occurs on the cathode side of the SOEC, which comprises of Nickel containing layers in their reduced state. On the oxy side of the SOEC (the anode), oxygen is produced and is normally flushed with air.

The flush air and produced oxygen has to be supplied/removed from each SOEC anode in the stack, which is normally done by channels to/from each anode compartment to a common manifold (which can be internal or external). The common anode (oxy) manifold is thus connecting the individual single repeat units of the stack and spans across the individual cells of the stack at the cell edge.

The way the anode and cathode gas flows are distributed in a SOC stack is by having a common manifold for each of the two process gasses. The manifolds can either be internal or external. The manifolds supply process gasses to the individual layers in the SOC stack by the means of channels to each layer. The channels are normally situated in one layer of the repeating elements which are comprised in the SOC stack, i.e. in the spacers or in the interconnect.

Spacers or interconnects normally have one inlet channel which is stamped, cut or etched all the way through the material. The reason for only having one inlet channel is that the spacer has to be an integral component. This solution allows for a cheap and controllable manufacturing of the spacer or interconnect channel, because controllable dimensions give controllable pressure drops.

Another way of making process gas channels, which allows for multi channels, is by etching, coining, pressing or in other ways making a channel partly through the spacer or interconnect. This means that the spacer can be an integral component, but the method of making the channels partly through the material is not precise, which gives an uncertain and uncontrollable pressure-drop in the gas channels.

If a sealing material is applied across gas channels which are formed only partly through the material of the spacer or the interconnect, more uncertain and uncontrollable pressure-drops in the gas channels will arise. The sealing material can of course be screen printed to match only the desired surfaces, or glued and cut away from the gas channels, which will lower the risk of uncertain pressure-drops, but this is expensive and time-consuming.

Edge re-oxidation refers to a failure mechanism in soc stacks where the Nickel in the cathode layer (SOEC mode) is gradually re-oxidized from stack or cell edges exposed to oxygen containing gas (e.g. the oxy manifold), eventually leading to loss of gas tightness, lower yield due to combustion and eventually hard failure of the stack due to electrolyte cracks. This is especially the case for stack design where the cell is not inserted into a frame or cassette but has the same footprint as the other components in the stack.

The stack with same footprint of the cell and the other components in the stack (“cell-to-edge”) is believed to be more robust towards thermal gradients and changes, as the sealing area is made of the same layers and material as the active area. There are thus no mis-match between the CET (Coefficient of Thermal Expansion) of the materials used in the sealing area and the active area. This will be the case for a stack concept with frame or cassettes, where the cell is not located in the sealing area-the stack thus has different CET in the active area compared with the sealing area.

If the cell edges, in a stack with same footprint of cell and the rest of the components, are covered/encapsulated in glass, used for sealing the individual components of the stack, the oxygen from the oxy manifold cannot diffuse into the Nickel containing layers and thus edge re-oxidation is avoided. The cell edge can be covered in glass if the edge of the cell is withdrawn slightly compared with the edge of the layers next to the cell, often the Oxy and fuel spacer, but for instance in some cases the interconnect.

The cathode side of the SOEC (fuel side) are often made with contact enabling layer between the interconnect and the fuel side of the cell. This contact enabling layer is often made of a Nickel mesh or foil.

A challenge is to position and fix the contact enabling layer correct and safe, especially during assembly and conditioning of the stack.

During assembly and conditioning of the SOC stack, several components are stacked and joint together. The individual layers in the SOC stack (Cell, IC, spacers, gaskets, . . . ) are normally stacked individually, which allows for misalignment during stacking or conditioning leading to possible leaks, flow maldistribution or contact related issues.

The individual layers can be joined in sub-assemblies before the stacking of the SOC stack by gluing or welding the components together. This can reduce risk of misalignment but involves introducing an adhesion (glue) or a welding process for the sole purpose of fixating the components together during assembly and conditioning. The fixation of the sub-components by glue or welding is not being used during operation where all the components are conditioned together to form the stack. Hence, this is a cumbersome and expensive solution.

U.S. Pat. No. 6,492,053 discloses a fuel cell stack including an interconnect and a spacer. Both, the interconnect and the spacer, have inlet and outlet manifolds for the flow of oxygen/fuel. The inlet and outlet manifolds have grooves/passages on its surface for the distribution of oxygen/fuel along the anode and cathode. However, the grooves/passages of the interconnect and spacer are not aligned with each other and hence their geometries could not be combined to achieve multiple inlet points. Also, since the grooves/passages are on the surface of both the interconnect and spacers, the formation of multiple inlet points are not feasible.

US2010297535 discloses a bipolar plate of a fuel cell with flow channels. The flow plate has multiple channels for distributing fluid uniformly between the active area of the fuel cell. The document does not describe a second layer and similar channels within it.

US2005016729 discloses a ceramic fuel cell(s) which is supported in a heat conductive interconnect plate, and a plurality of plates form a conductive heater named a stack. Connecting a plurality of stacks forms a stick of fuel cells. By connecting a plurality of sticks end to end, a string of fuel cells is formed. The length of the string can be one thousand feet or more, sized to penetrate an underground resource layer, for example of oil. A pre-heater brings the string to an operating temperature exceeding 700 DEG C., and then the fuel cells maintain that temperature via a plurality of conduits feeding the fuel cells fuel and an oxidant, and transferring exhaust gases to a planetary surface. A manifold can be used between the string and the planetary surface to continue the plurality of conduits and act as a heat exchanger between exhaust gases and oxidants/fuel.

None of the above described known art provides a simple, efficient and fail-safe solution to the above described problems.

Therefore, with reference to the above listed considerations, there is a need for a simple, cheap and easy but still robust and precise solution to produce an integrated interconnect and spacer comprising a fixture for a contact enabling layer on at least one side of the integrated interconnect and spacer.

These and other objects are achieved by the invention as described below.

### SUMMARY OF THE INVENTION

The invention is to make a single component (which combines the functionalities of the interconnect and spacer) in sheet metal by folding the spacer part from the IC sheet onto the one side of the sheet metal. Folding (or bending) is a mass preserving process, hence there is no waste.
The folding radius is dependent of the sheet thickness, when folding thin sheet material as in the present invention, very small folding radius can be obtained.

By folding the spacer from the interconnect sheet metal, several issues are solved:
Reduction of sealing areas in the stack and thus fewer places where leak can occur, while saving a sealing layer per interconnect-spacer assembly.
Reduction of components to be handled in production.
As the spacer is made of the same sheet metal as the interconnect, the thickness of the interconnect and the spacer is the same, thus reducing tolerance issues in the stack assembly.
When spacers are made from a separate sheet metal, the material use is greater as the sealing area normally located in the periphery of the interconnect. The folded solution thus saves material, as the folded part is included in the interconnect periphery, and the “internal” of the spacer is used for interconnect.
Identical material of the interconnect and spacer (and no sealing material) yields same coefficient of thermal expansion.
As the spacer is part of the interconnect, the alignment of a separate spacer part is eliminated.
The folding process is cheap and industrial scalable.

To produce the integrated interconnect and spacer, the interconnect geometry is enlarged to include the spacers, which are then folded on top of the interconnect. The folding process is simple and robust and used in several industries (e.g. metal cans).

The thickness of the spacer is the same as the thickness of the interconnect, plus the thickness of any material which is added between the interconnect and spacer. This reduces tolerances when assembling the stack. The same tolerances cannot be achieved by other processes, i.e. etching a seal between interconnect and spacer is saved. As the interconnect and spacer become one component, it saves on handling of components. As spacers are usually placed in the periphery of the interconnect, the centre is cut out and wasted using a standard solution. When the spacer is part of the interconnect, the internal of the spacer is not wasted, reducing material waste.

Furthermore, the invention includes integrated oxy channels “inside” the interconnect-spacer assembly of the SOC stack, which enables the oxy channels to be free from exposure to the glass used to encapsulate the edges of the cells.

The oxy channels are formed in both the interconnect and the spacer, but only a little more than half way through the sealing area in each component. The channels in the interconnect and the channels in the spacer then overlaps to create a single channel all the way through the sealing area.

This way, the outer edge of the Oxy spacer can be made without channels, enabling the coverage of the cell edge all over without having glass entering the oxy channels.

According to the invention a contact enabling layer is fixed on at least one side of the integrated interconnect and spacer assembly (IC assembly).

The fixation of the contact enabling layer (which may for instance be a Nickel-foil) in the Integrated interconnect and spacer assembly can be done in different ways which are all according to the invention:

1) Fixation during folding of the IC assembly:

If the contact enabling layer is made large enough, so it extends to the sealing area of the IC assembly and is placed on the IC assembly before this is folded, the contact enabling layer can be fixed between the IC and the spacer in the folded IC assembly. The sealing area of the IC assembly with fixated contact enabling layer thus consists of IC+Ni-foil+spacer and the thickness of the sealing area is thus the sum of the 3 layers.

2) Fixation after folding of the IC assembly:

By making slots or indentations under the spacer part of the IC assembly, the contact enabling layer can be inserted and fixated after the folding of the IC assembly. This can of course be done during the folding process but is also possible to do done after, making a sub-assembly before the stack assembly. The indentations in the drawings can for instance be made by etching (or any other known material removing or deforming process) partly through the spacer part of the IC assembly before the assembly is folded.

The contact enabling layer on at least one side of the integrated interconnect and spacer is fixed to the integrated interconnect and spacer assembly to a sub-component before stack assembly without using glue or welding process. Misalignment of these components during stacking and conditioning is thus minimized both compared with having no sub-assembly but also compared with making sub-assemblies by gluing or welding which is less precise (has higher tolerances) than the fixation according to the invention.

It is to be understood that both the fuel and the oxy-spacers and fixation of contact enabling layers can be made according to the present invention for both SOEC and SOFC stacks as mentioned earlier.

The invention according to claim 1 is a Solid Oxide Cell stack comprising a plurality of stacked cell units. Each of the cell units comprises a cell layer, with anode, cathode and electrolyte and an interconnect layer. The layers are stacked alternating so that one interconnect layer separates one cell layer from the adjacent cell layer in the cell stack. The interconnect layer comprises an integrated interconnect and spacer which is made from one piece of plate with the thickness T, instead of having a separate spacer as known in the art. The spacer is formed by bending at least a part of the edges of the interconnect 180° a number, N, of time to provide a spacer which covers at least a part of the edges of the interconnect. It is to be understood that the bend is 180° with the tolerances which are inherent and common for the production process of bending, which may also include some degree of flexing back. Also, it is to be understood that the piece of plate to be bent before bending has dimensions larger than the final integrated interconnect and spacer, where the surplus area is to be bent and will form the spacer after the bend. After bending, the spacer and interconnect together form an edge of at least a part of the integrated interconnect and spacer (with a thickness equal to or less than (1+N) times the thickness of the plate T and plus the thickness of any material added in between the interconnect and the spacer or on either side of it, it is to be understood that the thickness depends of material and production tolerances which may lead to measures slightly larger or smaller than the above mentioned thickness, which is therefore within the scope of the claim). It is however a part of the invention that the bending process may also provide a higher accuracy than known from common solid oxide cell stacks, since a gasket between spacer and interconnect is omitted and because the bending process may be followed by an accurate press which evens the thickness of the integrated interconnect and spacer to fine tolerances. It is to be understood that contact between the cells by the integrated interconnect and spacer is ensured both by the bent edges as well as by contact points throughout the surface of the integrated interconnect and spacer. The contact points may be provided by a contact enabling element provided on the same side of the interconnect as the bent. The contact enabling element may be in the form of a net, by pressed contact points or any other known art. According to claim 1, the invention further comprises a contact enabling layer and a fixture for said contact enabling layer. According to the invention, at least a part of the spacer provides the fixture for the contact enabling layer, which is provided on at least one side of the integrated interconnect and spacer. According to the invention, the spacer may provide the fixture of the contact enabling layer in several ways, which will be apparent from the following embodiments of the invention.

According to a further embodiment of the invention, the contact enabling layer is located on a fuel side of the integrated interconnect and spacer, which faces a fuel side of an adjacent cell layer. In this embodiment the contact enabling layer is only on one side of the integrated interconnect and spacer, the fuel side. It is to be understood that the contact enabling layer may in another embodiment be on the other side of the integrated interconnect and spacer (the oxy side), or in at further embodiment on both sides of the integrated interconnect and spacer.

In an embodiment of the invention, a part of the spacer overlaps at least a part of the contact enabling layer and thus ensures the position of said contact enabling layer by fixing said part of the contact enabling layer between said part of the spacer and the interconnect. In this embodiment, the spacer or the contact enabling layer may have protrusions which ensures the overlap to enable the fixation of the contact enabling layer; or the contact enabling layer may simply overall have a slightly larger outer area than the inner edge of the spacer, when bent, or a combination of the above or another known solution.

In a further embodiment of the invention, the contact enabling layer provides a gas tight sealing between at least a part of the spacer and the interconnect. This may be the case in the area of the fixation, provided by a simple physical barrier formed between the layers when the contact enabling layer is fixed, but it may also for instance be in the form of a bonding between the layers, for instance a metal bonding.

In another embodiment of the invention, at least a part of the edge of the spacer comprises one or more indentations adapted to provide the fixture for the contact enabling layer. As described in the above this indentation is then formed between the rest of the spacer edge at that area and the interconnect, and the contact enabling layer may be positioned with a part within the indentation after the spacer has been folded onto the interconnect or before. This embodiment is also further visualized in some of the drawings.

The indentations can be made in any way known in the art. In an embodiment, the indentations are made by etching away material of the spacer, in other embodiments the indentations are made by for instance coining or embossing. The indentations can be made both by removing material or by plastic deforming of the spacer. In an embodiment of the invention, the indentations are made on the side of the spacer which is facing the interconnect after the bend.

In an embodiment of the invention, the integrated interconnect and spacer has a thickness which is equal to or less than (1+N) times the thickness of the plate T. Thus, when the edge of the interconnect is bent onto the rest of the interconnect (and thereby becomes a spacer), the total thickness of the integrated interconnect and spacer is the sum of the thickness of each of the layers, which are all from the same material with the same thickness T; the total thickness may however be less than said sum, it the bend process is ended with a plastic deforming press, which may also serve to even out the thickness of all the edges of the integrated interconnect and spacer, a calibrating step in the bend process.

In a particular embodiment of the invention, at least part of the edges of the interconnect is bent 180° one time, which provides an interconnect and spacer with a thickness equal to or less than 2 times the thickness of the plate T.

In an embodiment of the invention, the spacer may be at least partly formed by a contiguous fluid tight edge. The fluid tight edge may be adapted to form a fluid tight seal towards an external manifold or around an internal manifold. Apart from the fold itself, the spacer may be further connected to the interconnect by diffusion bonding (wherein the atoms of two solid, metallic surfaces intersperse themselves over time), welding or any other suitable connecting technique on at least a part of the edge or surface of the spacer. In an embodiment of the invention, the spacer of the integrated interconnect and spacer is at least partly formed by a contiguous fluid tight edge adapted to form a fluid tight seal around an internal manifold.

In an embodiment of the invention, the bend is facilitated and guided by grooves on one, the other, or both sides of the interconnect in at least a part of the bending lines. Grooves may be present on at least one side of the interconnect to form flow fields for process fluid. Said grooves may be formed by for instance etching, coining, embossing or any known technique.

In an embodiment of the invention as also described before, the contact enabling layer may be a mesh or a foil; the contact enabling layer may be made of for instance nickel.

In an embodiment of the invention, the stack is a Solid Oxide Electrolysis Cell stack with operating temperatures as mentioned above. In a further embodiment of the invention, the stack is a Solid Oxide Fuel Cell stack. The sheet metal used to manufacture the integrated interconnect and spacer may be austenitic steel, ferritic steel or any alloy best suited for the stack.

### FEATURES OF THE INVENTION

1. Solid Oxide Cell stack comprising a plurality of stacked cell units, each cell unit comprises a cell layer, a contact enabling layer and an interconnect layer, one interconnect layer separates one cell layer from the adjacent cell layer in the cell stack, wherein the interconnect layer comprises an integrated interconnect and spacer made from one piece of plate with the thickness, T, the spacer is formed by at least a part of the edges of the interconnect which is bent 180° a number, N, of times to provide a spacer covering at least a part of the edges of the interconnect, so said spacer and interconnect together form an edge of at least a part of the integrated interconnect and spacer and wherein at least a part of said spacer further provides a fixture for said contact enabling layer which ensures the position of said contact enabling layer on at least one side of the integrated interconnect and spacer.

2. Solid Oxide Cell stack according to feature 1, wherein said contact enabling layer is located on a fuel side of the integrated interconnect and spacer which faces a fuel side of an adjacent cell layer.

3. Solid Oxide Cell stack according to any of the preceding features, wherein a part of the spacer overlaps at least a part of the contact enabling layer and ensures the position of said contact enabling layer by fixing said part of the contact enabling layer between said part of the spacer and the interconnect.

4. Solid Oxide Cell stack according to any of the preceding features, wherein said contact enabling layer provides a gas tight sealing between at least a part of the spacer and the interconnect.

5. Solid Oxide Cell stack according to any of the preceding features, wherein at least a part of the edge of the spacer comprises one or more indentations adapted to provide said fixture for the contact enabling layer.

6. Solid Oxide Cell stack according to feature 5, wherein said indentations are made by etching away a part of the edge of the spacer.

7. Solid Oxide Cell stack according to feature 5, wherein said indentations are made by coining or embossing.

8. Solid Oxide Cell stack according to feature 5, 6 or 7, wherein said indentations are made on the side of the spacer which is facing the interconnect after said bend.

9. Solid Oxide Cell stack according to any of the preceding features, wherein the integrated interconnect and spacer has a thickness which is equal to or less than (1+N) times the thickness of the plate T.

10. Solid Oxide Cell stack according to any of the preceding features, wherein the at least part of the edges of the interconnect is bent 180° one time to provide a spacer covering at least a part of the edges of the interconnect, so said spacer and interconnect together form an edge of at least a part of the integrated interconnect and spacer with a thickness equal to or less than 2 times the thickness of the plate T.

11. Solid Oxide Cell stack according to any of the preceding features, wherein the spacer of the integrated interconnect and spacer is at least partly formed by a contiguous fluid tight edge.

12. Solid Oxide Cell stack according to any of the preceding features, wherein the spacer of the integrated interconnect and spacer is at least partly formed by a contiguous fluid tight edge adapted to form a fluid tight seal towards an external manifold.

13. Solid Oxide Cell stack according to any of the preceding features, wherein the spacer of the integrated interconnect and spacer is at least partly formed by a contiguous fluid tight edge adapted to form a fluid tight seal around an internal manifold.

14. Solid Oxide Cell stack according to any of the preceding features, wherein the spacer is connected to the interconnect not only by the bent part, but additionally on at least one further edge or surface of the spacer facing the interconnect.

15. Solid Oxide Cell stack according to any of the preceding features, wherein the spacer is connected to the interconnect by diffusion bonding on at least a part of the surface of the spacer facing the interconnect.

16. Solid Oxide Cell stack according to any of the preceding features, wherein the spacer is connected to the interconnect by welding on at least a part of the surface of the spacer facing the interconnect.

17. Solid Oxide Cell stack according to any of the preceding features, wherein the interconnect has grooves on at least one side adapted to facilitate and guide said 180° a number, N, of times bend.

18. Solid Oxide Cell stack according to any of the preceding features, wherein the interconnect has grooves on at least one side adapted to form flow fields for process fluid.

19. Solid Oxide Cell stack according to any of the preceding features, wherein the interconnect has grooves formed by etching or coining or embossing on at least one side to form flow fields for process fluid.

20. Solid Oxide Cell stack according to any of the preceding features, wherein the contact enabling layer is a mesh or a foil.

21. Solid Oxide Cell stack according to any of the preceding features, wherein the contact enabling layer is a nickel mesh or a nickel foil

22. Solid Oxide Cell stack according to any of the preceding features, wherein the Solid Oxide Cell stack is a Solid Oxide Electrolysis Cell stack.

### BRIEF DESCRIPTION OF THE DRAWINGS

The invention is further illustrated by the accompanying drawings showing examples of embodiments of the invention.

FIG. 1 shows an side view of an integrated interconnect, spacer and contact enabling layer after folding, according to an embodiment of the invention.

FIG. 2 shows an side view of an integrated interconnect, spacer and contact enabling layer after folding, according to an other embodiment of the invention.

FIG. 3 shows an angled view of an integrated interconnect, spacer and contact enabling layer after folding, according to an embodiment of the invention.

### POSITION NUMBERS

01. Integrated interconnect and spacer

02. Spacer

03. Contact enabling layer

04. Fixture for contact enabling layer

05. Indentation in spacer

### DETAILED DESCRIPTION

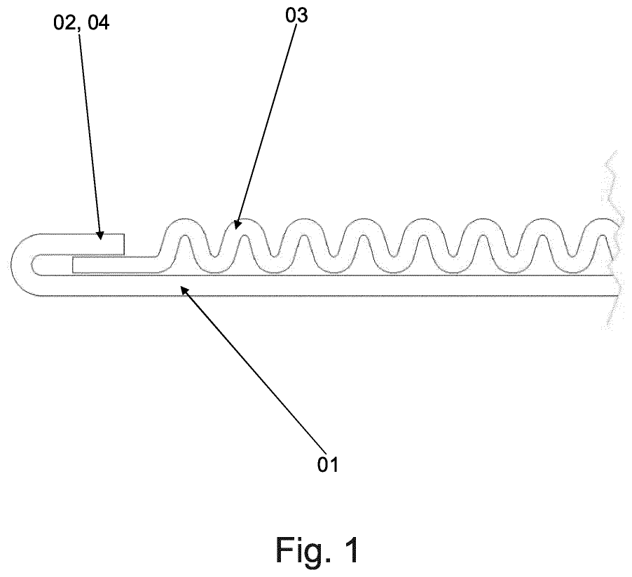

FIG. 1 shows an integrated interconnect and spacer 01 for a Solid Oxide Cell stack (not shown) seen from the side. The view is of and integrated interconnect and spacer after a bend, where a part of the interconnect has in this embodiment been bended one time to form a spacer 02. The in-bended spacer forms a fixture 04 for the contact enabling layer 03, which in this embodiment is located on one side of the integrated interconnect and spacer. In this embodiment, the contact enabling layer has a part or all of its edge, which is protruding in under a part of the in-bended spacer. The fixture is formed as the opening between the spacer and the interconnect around the protruding part of the contact enabling layer. The fixture may form a hard fix of the contact enabling layer, e.g. if the spacer is bent onto the contact enabling layer and pressed, so the contact enabling layer is pressed/squeezed between the spacer and the interconnect. The thickness of the integrated interconnect and spacer may in this embodiment be larger than two times the thickness of the interconnect, since the contact enabling layer is positioned between the interconnect and the spacer, unless the spacer is pressed so hard onto the contact enabling layer and the interconnect that a plastic deformation takes place, in which case the thickness may be equal to or even smaller than two times the thickness of the interconnect.

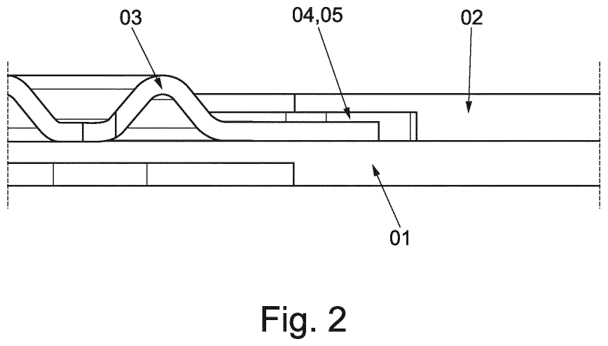

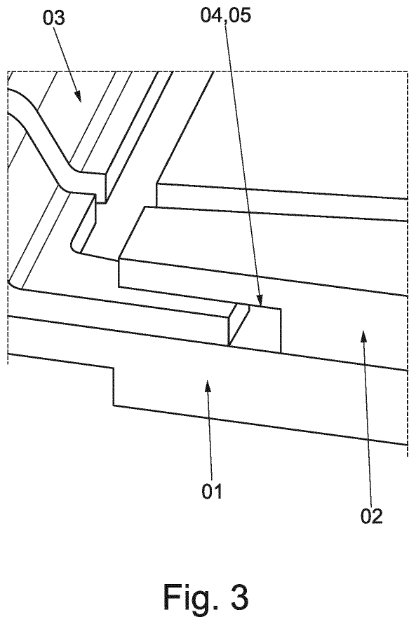

FIG. 2 shows another embodiment of the invention. The elements and the position of the elements are almost the same as in the embodiment of FIG. 1, only in this embodiment, an indentation 05 is made in a part of the spacer which is facing the interconnect when the spacer is bent onto the interconnect. The indentation is forming a space/void which fits a part of the contact enabling layer, which is thereby fixed. This fixation of the contact enabling layer may be loose, to make it possible to position and fix the contact enabling layer to the integrated interconnect and spacer after the spacer has been bent onto the interconnect. In FIG. 3 the embodiment of FIG. 2 is shown in an angled view.

1. Solid Oxide Cell stack comprising a plurality of stacked cell units, each cell unit comprises a cell layer, a contact enabling layer and an interconnect layer, one interconnect layer separates one cell layer from the adjacent cell layer in the cell stack, wherein the interconnect layer comprises an integrated interconnect and spacer made from one piece of plate with the thickness, T, the spacer is formed by at least a part of the edges of the interconnect which is bent 180° a number, N, of times to provide a spacer covering at least a part of the edges of the interconnect, so said spacer and interconnect together form an edge of at least a part of the integrated interconnect and spacer and wherein at least a part of said spacer further provides a fixture for said contact enabling layer which ensures the position of said contact enabling layer on at least one side of the integrated interconnect and spacer.

2. Solid Oxide Cell stack according to claim 1, wherein said contact enabling layer is located on a fuel side of the integrated interconnect and spacer which faces a fuel side of an adjacent cell layer.

3. Solid Oxide Cell stack according to claim 1, wherein a part of the spacer overlaps at least a part of the contact enabling layer and ensures the position of said contact enabling layer by fixing said part of the contact enabling layer between said part of the spacer and the interconnect.

4. Solid Oxide Cell stack according to claim 1, wherein said contact enabling layer provides a gas tight sealing between at least a part of the spacer and the interconnect.

5. Solid Oxide Cell stack according to claim 1, wherein at least a part of the edge of the spacer comprises one or more indentations adapted to provide said fixture for the contact enabling layer.

6. Solid Oxide Cell stack according to claim 5, wherein said indentations are made by etching away a part of the edge of the spacer.

7. Solid Oxide Cell stack according to claim 5, wherein said indentations are made by coining or embossing.

8. Solid Oxide Cell stack according to claim 5, wherein said indentations are made on the side of the spacer which is facing the interconnect after said bend.

9. Solid Oxide Cell stack according to claim 1, wherein the integrated interconnect and spacer has a thickness which is equal to or less than (1+N) times the thickness of the plate T.

10. Solid Oxide Cell stack according to claim 1, wherein the at least part of the edges of the interconnect is bent 180° one time to provide a spacer covering at least a part of the edges of the interconnect, so said spacer and interconnect together form an edge of at least a part of the integrated interconnect and spacer with a thickness equal to or less than 2 times the thickness of the plate T.

11. Solid Oxide Cell stack according to claim 1, wherein the spacer of the integrated interconnect and spacer is at least partly formed by a contiguous fluid tight edge.

12. Solid Oxide Cell stack according to claim 1, wherein the spacer of the integrated interconnect and spacer is at least partly formed by a contiguous fluid tight edge adapted to form a fluid tight seal towards an external manifold.

13. Solid Oxide Cell stack according to claim 1, wherein the spacer of the integrated interconnect and spacer is at least partly formed by a contiguous fluid tight edge adapted to form a fluid tight seal around an internal manifold.

14. Solid Oxide Cell stack according to claim 1, wherein the spacer is connected to the interconnect not only by the bent part, but additionally on at least one further edge or surface of the spacer facing the interconnect.

15. Solid Oxide Cell stack according to claim 1, wherein the spacer is connected to the interconnect by diffusion bonding on at least a part of the surface of the spacer facing the interconnect.

16. Solid Oxide Cell stack according to claim 1, wherein the spacer is connected to the interconnect by welding on at least a part of the surface of the spacer facing the interconnect.

17. Solid Oxide Cell stack according to claim 1, wherein the interconnect has grooves on at least one side adapted to facilitate and guide said 180° a number, N, of times bend.

18. Solid Oxide Cell stack according to claim 1, wherein the interconnect has grooves on at least one side adapted to form flow fields for process fluid.

19. Solid Oxide Cell stack according to claim 1, wherein the interconnect has grooves formed by etching or coining or embossing on at least one side to form flow fields for process fluid.

20. Solid Oxide Cell stack according to claim 1, wherein the contact enabling layer is a mesh or a foil.

21. Solid Oxide Cell stack according to claim 1, wherein the contact enabling layer is a nickel mesh or a nickel foil.

22. Solid Oxide Cell stack according to claim 1, wherein the Solid Oxide Cell stack is a Solid Oxide Electrolysis Cell stack.
